(19) United States
(12) Patent Application Publication
(10) Pub. No.: US 2025/0233432 A1
(43) Pub. Date: Jul. 17, 2025

(54) Universal Charging/Docking Station and Cradle With Intelligent Updating and Power Configuration and Modular Physical Structure

(71) Applicant: KoamTac, Inc., Princeton, NJ (US)

(72) Inventor: Hanjin Lee, Skillman, NJ (US)

(73) Assignee: KoamTac, Inc., Princeton, NJ (US)

(21) Appl. No.: 18/999,803

(22) Filed: Dec. 23, 2024

Related U.S. Application Data
(60) Provisional application No. 63/620,274, filed on Jan. 12, 2024.

(51) Int. Cl. H02J 7/00

(52) U.S. Cl. CPC H02J 7/0044; H02J 7/00034

(57) ABSTRACT

A docking station and charging cradle for holding and charging devices, wherein the charging feature is such that it can be adapted to receive and charge practically any type of portable electronic device includes a base that can be removed and used by itself as a cradle and charger on a flat surface. The base includes at least one docking cavity that can physically and electrically couple the base to portable electronic devices such that the devices are supported by the dock while they are being charged. Modular adapters with firmware auto-update can also be inserted into the docking cavities to reconfigure the cavity to physically support a different type of device.

The present application claims priority from U.S. provisional application No. 63/620,274, filed on Jan. 12, 2024, which is hereby incorporated by reference in its entirety.

### BACKGROUND OF THE INVENTION

Attempts to provide versatile charging docks for electronic devices have been known in the industry, for example, one such as the “2-Device Universal Charging Unit” and other types of charging docks available from GPSLockbox® of Las Vegas, NV. These products and others lack, among other things, the ability to provide versatility beyond just 2 charging pins or lack the ability to accommodate different electronic devices by say, varying voltages according to intelligent firmware and/or specialized circuitry, and moreover, are essentially glorified extensions of a standard USB adapter. Other attempts have been made that purportedly vary voltage, such as seen in one exemplary document, U.S. Pat. No. 8,115,451 hereby incorporated by reference, but these known approaches also lack both the aforementioned variable pin offerings, and also lack the above-referenced intelligent circuitry for auto detecting the requisite voltage(s) of any given device that has been inserted.

Such deficiencies mean that different devices cannot be used in one charging dock, either due to different voltage requirements across various electronic devices, or because of physical mismatch between the docking cavity and the electronic device such that the docking station cannot physically support a different type of device than the originally supported device. In addition, such charging docks are often needed in both stationary environments (desks, tabletops, etc.) and movable environments (automobiles, forklifts, golf carts, etc.). As such, a comprehensive system that can physically support such docks is needed across all applications, as well as being universal in its ability to accommodate new or different electronic devices of varying sizes, voltages and the like.

### SUMMARY OF THE INVENTION

A universal charging docking station and cradle with intelligent power configuration having a modular physical structure is disclosed so that users can keep an automobile or non-automobile vehicle (such as a forklift, golf cart, construction machine, motor bike/ATV, etc.) equipped with a charger system that can be employed for a long time even when replacing or upgrading to a different or special phone model by just replacing spacers that nest within a charging cavity of the universal charging docking station and cradle unit. This modular design concept also contains firmware and/or micro logic embedded in specialized circuitry that can be used to auto detect spacer type and thereby, the size/type of electronic device (typically a phone or sometimes a tablet or the like) which has been inserted into the universal charging docking station and cradle. The charging base has at least one pin, or more commonly 2-4 pins to detect module type and provide proper power to each module. Each module employs a specialized logic flow based upon an algorithm, so as to provide customized and optimized power to any given electronic device. When the electronic device is seated or situated within the universal charging docking station and cradle, it can be retained within the cradle for retention as an affixment within a physically mobile vehicle, and/or removed from the cradle so that the charger may be used is a desktop cradle with a stabilization brim functions as a stability feature within a base stand.

### BRIEF DESCRIPTION OF DRAWINGS

FIG. 1 depicts an illustrative offset perspective of the invention, in one embodiment used in an automobile;

FIG. 2 depicts an illustrative offset perspective of the invention, in one embodiment used in a non-automotive vehicle or other mobile environment;

FIG. 3A depicts an illustrative backside offset perspective of the invention;

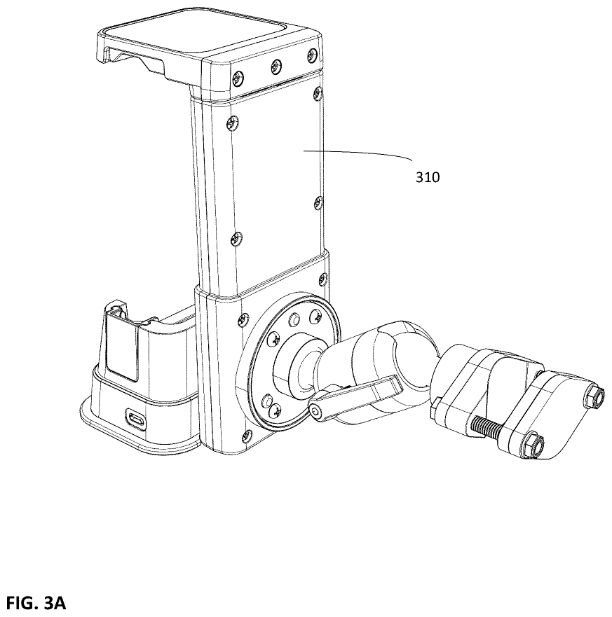

FIG. 3B depicts an illustrative underside offset perspective of the invention;

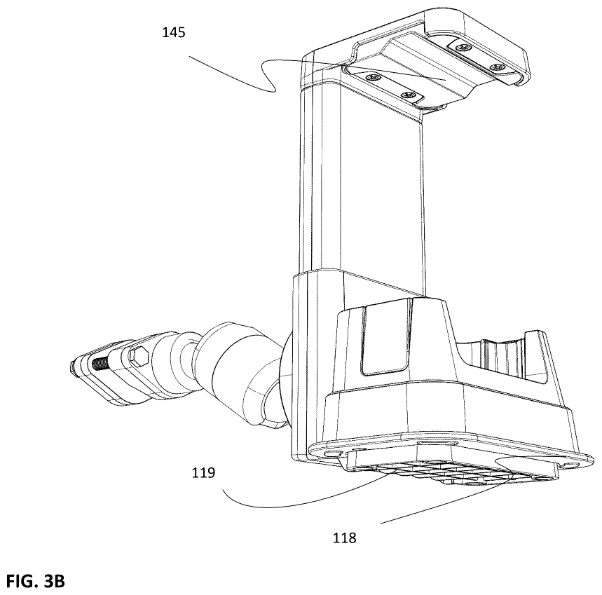

FIG. 4A depicts an illustrative offset perspective of the invention, in one embodiment of the charger and cradle having the intelligent charging spacers nested within the charging cavity, which may be used in either the automotive or non-automotive environments, or alternatively, by itself, independent of any cradle or attachment means, to house said electronic device(s) on a substantially flat surface such as a desk or table;

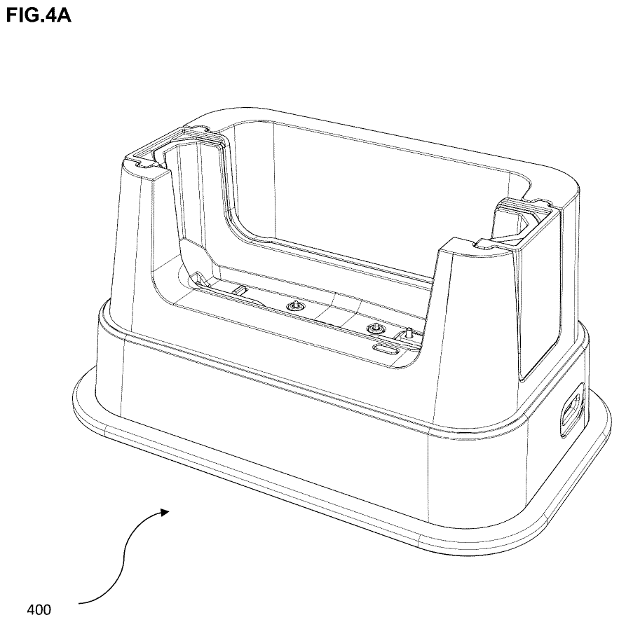

FIG. 4B depicts an illustrative offset exploded perspective of the invention, in one embodiment of the charger and cradle, respectively sized modular units for charging and receiving said electronic devices, which may be used in either the automotive or non-automotive environments, or alternatively, by itself, independent of any cradle or attachment means, to house said electronic device(s) on a substantially flat surface such as a desk or table;

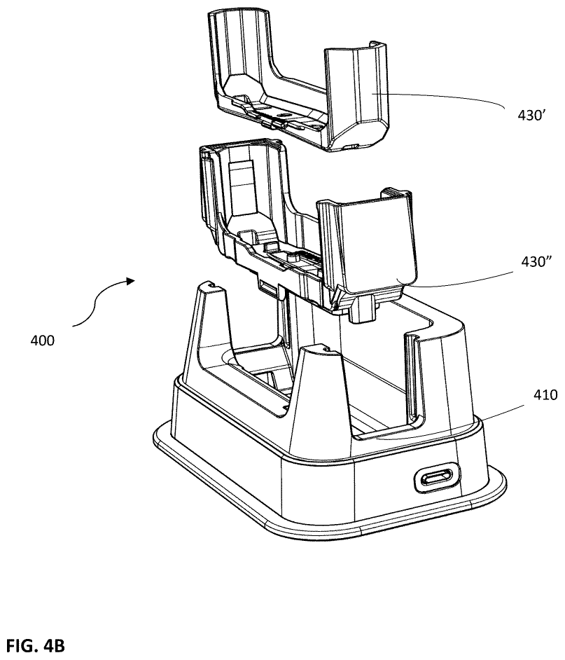

FIG. 5 depicts an illustrative offset exploded perspective of the invention, in one embodiment, with an attachment arm for affixing to a vehicle, such as a non-automobile;

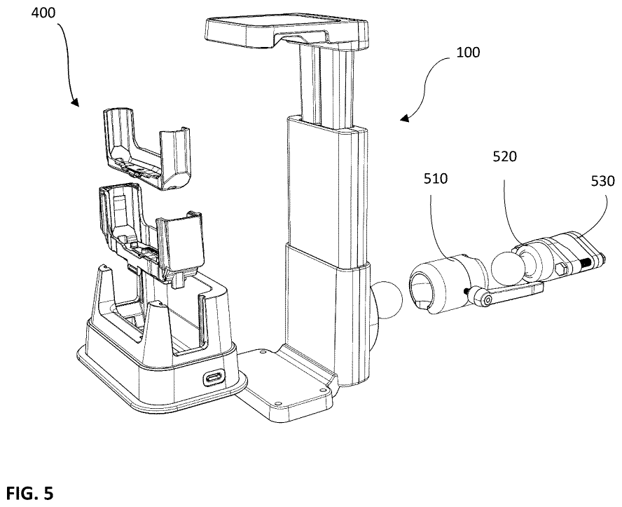

FIG. 6 depicts an illustrative offset exploded perspective of the invention, in one embodiment, with an attachment arm for affixing to a vehicle, such as an automobile;

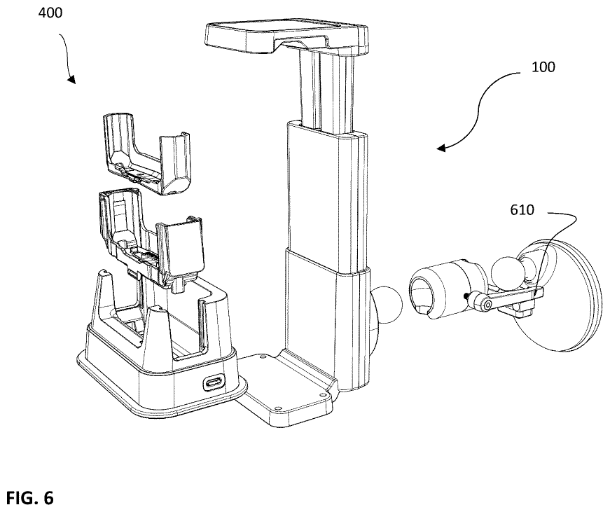

FIG. 7A depicts an illustrative block diagram of the inventive charger (without the associated cradle), in multi bay (device) employment, wherein the modular spacers are reflected interfacing with an intelligent circuitry;

FIG. 7B depicts an illustrative block diagram of the inventive charger, in multi bay (device) employment with optional battery add-on embodiments, wherein the resulting charging operative steps are shown;

FIG. 8 depicts an illustrative flow diagram of the intelligent logic inventive charger, detecting electronic devices that may have been inserted within the at least one charging cavity in a multi-bay environment, and detecting the input (power) source (USB port, fast charging USB adapter, power delivery, AC/DC adapter, etc.) of a given electronic device;

FIG. 9 depicts an illustrative flow diagram of the intelligent logic inventive charger, detecting and controlling the input (voltage) source of a given electronic device;

FIG. 10 depicts an illustrative flow diagram of the intelligent logic inventive charger checking the slot (modular) spacer as inserted, in terms of detection thereof;

FIG. 11 depicts an illustrative flow diagram of the intelligent logic inventive charger checking the fault parameters, for any of the situated electronic device within the charger unit;

FIG. 12 depicts an illustrative flow diagram of the intelligent logic inventive charger implementing an innovative recharge control function to minimize power consumption and so as to maximize battery life cycle;

FIG. 13 depicts an illustrative block diagram of the invention, in one embodiment entailing a 1-wire instantiation, of the physical and data connections between the host, spacer, and cradle;

FIG. 14 depicts an illustrative flow diagram of the intelligent logic inventive charger implementing an innovative firmware update function; and

FIG. 15 depicts an illustrative flow diagram of the intelligent logic inventive charger implementing, in further detail, an innovative firmware update function and the process flows between the relevant hardware portions involved in the overall charging apparatus.

### DETAILED DESCRIPTION OF THE INVENTION

At its broadest level, the present invention relates to a charging dock for charging at least two portable electronic devices, the charging dock comprising at least one charging station having at least one docking cavity that is adapted to mount and hold a portable electronic device in a secure position while the charging station is charging a power supply of the device, at least one spacer dimensioned to be positioned substantially inside said at least one docking cavity, thereby defining an interior dimension of the docking cavity for receiving a given portable electronic device having a given shape and size, when inserted therein; and an intelligent charging module connected to the charging station, wherein the intelligent charging module has specialized circuitry that detects correct voltage levels and adjusts a resulting voltage level when charging a given said portable electronic device. In one embodiment, the invention may further include firmware update circuitry for firmware updating said charging station and said spacer, a plurality of charging pins, a Unified Program and Debug Interface type connection with a 1-Wire, a cradle for securing said electronic device when affixed to a mobile vehicle. In yet a further alternative embodiment, the present invention may further include a “download spacer” in communication with said charging station.

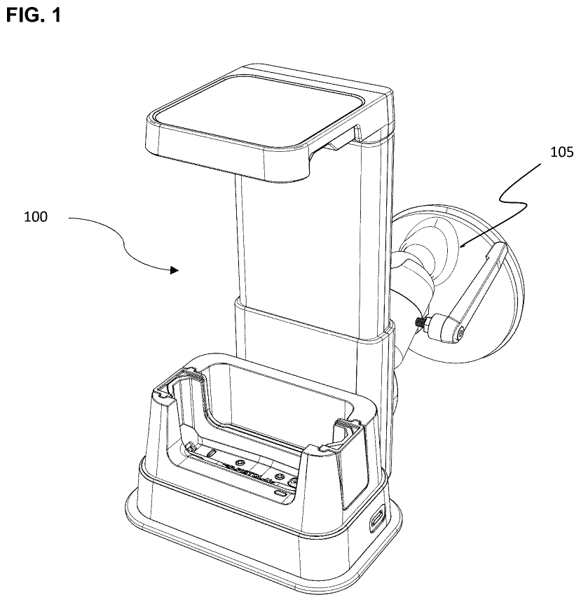

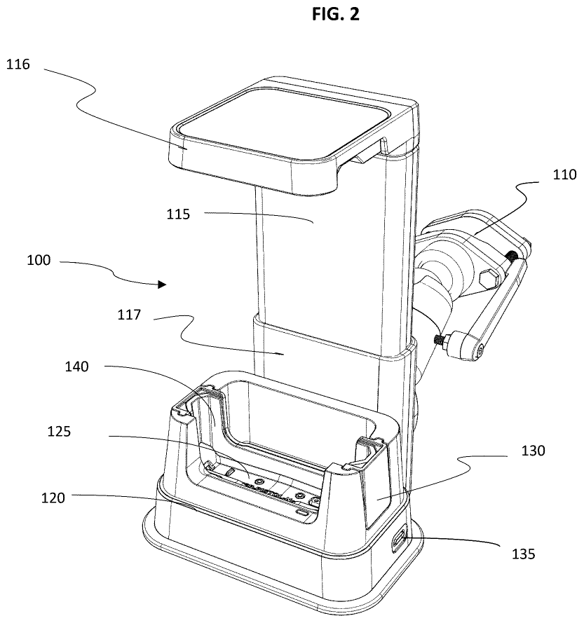

An illustration of a universal charging/docking station and cradle 100 constructed in accordance with an embodiment of the present invention, having an optional affixing means (which in one embodiment may be an automobile attachment means 105) is shown in FIG. 1. As seen in FIG. 2, an alternative embodiment may be in many different forms, such as the one illustrative example depicted as a non-automobile affixing means 110. Regardless of the type of affixing means employed (as well as in cases where no affixing means are used, as in the stand alone embodiment described hereafter), the universal charging/docking station and cradle 100 has a cradle 117 having a substantially vertical main body portion 115 with at least one affixed charger or charging station 400 and substantially horizontal affixing arms 116 for retaining charger 400 (and by extension, any electronic devices docked within said charger 400) by compression (clamping) between the affixing arms 116. Each docking station has at least one charging pin(s) 125 situated within a supportive charger cavity 140, at least one spacer 130 (shown as multiple spacers nested within each other inside the charge cavity 140, a connector 135 that is adapted to physically and electrically connect a portable electronic device to the electronic device seated withing the charger capacity 140. Supportive inner cavity 140 is, in one embodiment, formed in the upper surface of the main body portion 120 of charger 400. The main body portion 120 contains internal voltage conditioning circuitry that receives electrical power through a household plug and cable (or through an optional battery) and converts the electrical power into the voltage and current required by the devices for which the connectors 135 in the charging stations 400 is designed. In the embodiment shown, charging station(s) 400 contain at least one pin connector(s) 125 adapted to couple to an electronic device such as a tablet or mobile phone. However, alternative types of connectors, such as inductive charger solutions as known in the art can be used if desired.

One alternative embodiment provides for a multi-bay cradle solution, rather than a single bay solution, wherein a user can enable simultaneous charging of almost any desired number of devices. Because of the novel versatility of the present invention, it is possible to charge different devices simply by changing device spacer on the cradle base. By way of comparison, because any given cradle can be structured for multiple charge cavities 140 (with each charge cavity 140 accepting its own spacer 130, whether the same or different spacer 130 size and voltage) a one slot cradle can (in one embodiment) charge up to two devices at the same time, while a five slot cradle can charge up to ten devices in one embodiment. The charging of charging station 400 may be accomplished via any means known in the art, such as by using USB-C, USB PD, Samsung AFC charger and charging adaptors, etc. Enable to update firmware of cradle base and device spacer.

Modular adapters or spacers 130 therefore allow a user to customize the charging station(s) 400 to accept the particular type of devices that they need to charge. The adapters are preferably constructed from a unitary piece of plastic or varying sizes and fitments. The adapters 130 can be inserted into the supportive inner cavity 140 of any given charging station 400 to configure the stations to receive the different types of portable electronic device. The spacers 130 alter the inner dimensions (whether narrowing, or expanding, as in the case of larger tablets and the like) of the supportive inner cavity 140 so that devices of different sizes and shapes can be securely held by the cavity 140. Holes (not shown) in the spacers 130 allow the connectors 135 to be coupled to a corresponding connector on a device being charged through the adapter.

In one embodiment, provision is made of a base 4 pin implementation. In this illustrative embodiment (each of which is not necessarily depicted), what is termed a VBUS is essentially a pin to connect the VBUS power of spacer 130, and GND, or ground pin connect the GND of the spacer, while the Status/UPDI pin is employed to either check status of the device/battery mounted on the spacer or to download firmware of base/spacer status signal for device insertion/ejection determination, and/or the signal to determine the completion of charging of the battery, utilizing the UPDI 1-wire communication to update firmware and then, utilizing the Spacer ID pin for reading unique ID values between spacers.

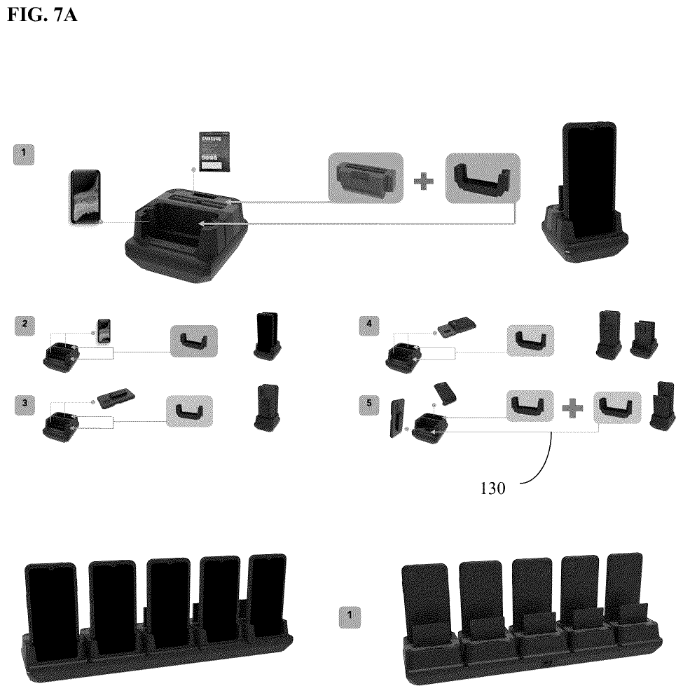

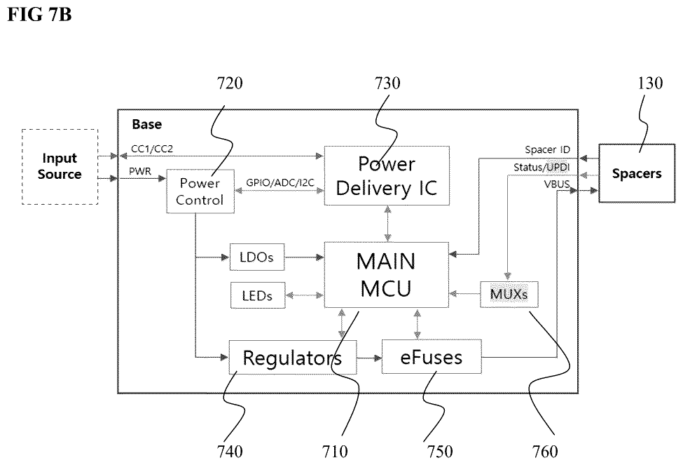

As shown in FIG. 7A, electronic devices such as tablets (not shown) or mobile phones are supported in an upright (or other stable position, such as flat, reclined, angled, etc.) fashion such that the display and controls (not depicted) of the devices are easily accessible. This is particularly important for mobile phones and digital media players that often need charging while they are being used. In addition, the upright mounting posture allows individual users to more easily identify their particular device when it is mounted near a similar type of device. The adapters allow the chamber to be reconfigured so that even if a device has different dimensions, it can be firmly supported in an upright position when mounted in the cavity.

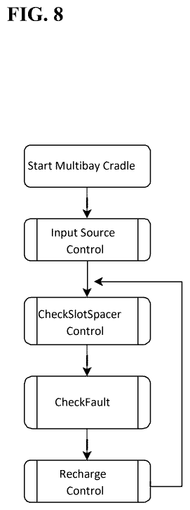

As depicted throughout FIGS. 7A-12, the intelligent power control circuitry, illustrative portions of which are depicted in FIG. 7B, which includes in a multi-bay embodiment, Main MCU 710, power control 720, power delivery 730, regulators 740 (which convert the received DC power into the required charging voltage and supply it to Spacer 130 regardless of changes in the input voltage), eFuses 750 (which protects the docked device and charger 400 by either stopping the provision of power or reduces current if fault is detected, by utilizing Undervoltage Protection (UVP). Overvoltage Protection (OVP), Overcurrent Protection (OCP), and Overtemperature Protection (OTP)) and multiplexer 760, all found in charger 400 in one embodiment. Provision of such allows for the proper output voltage and current to any given electronic device docked in charger 400 that is adapted to couple to the device for which spacer 130 is designed. Each docking station has a connector 135 adapted to mate with the particular device to be charged. The charging voltage from an illustrative USB input as seen in FIG. 8 is electrically coupled to an appropriate electrical contact (pins) on the connector to charge the device when the device is docked in the charging station 400. The modular spacer 130 can be snapped or otherwise fitted into the charging station 400 so as to connect to a charging station 400 and so as to configure the docking station to accept the alternative type of electronic device. These spacers 130 can be used to provide a wide range of alternative voltages for different devices by altering the voltage output that is electrically connected to the charging contact of the adapter output. In one embodiment, variable pin offerings, are provided for, along with the above-referenced intelligent circuitry for auto detecting the requisite voltage(s) of any given device that has been inserted. Thus, a proper set of adapters or spacers allow a user to configure the charger to accept the particular types of devices that they are utilizing via download through a UPDI module (as described hereafter) into logic/circuits with embedded micro code or the like, rather than using say, a USB port or the like.

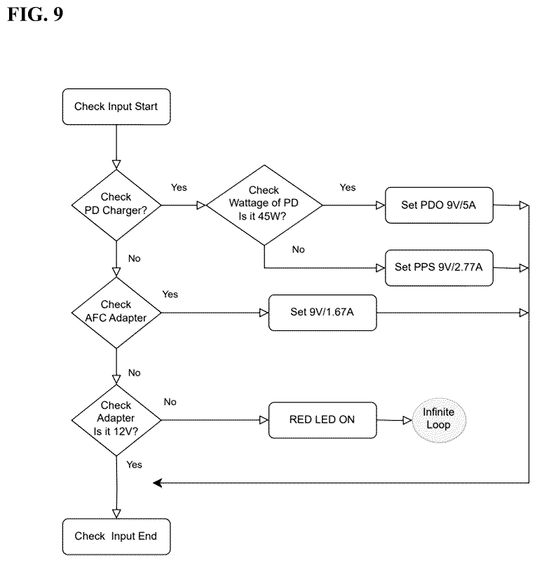

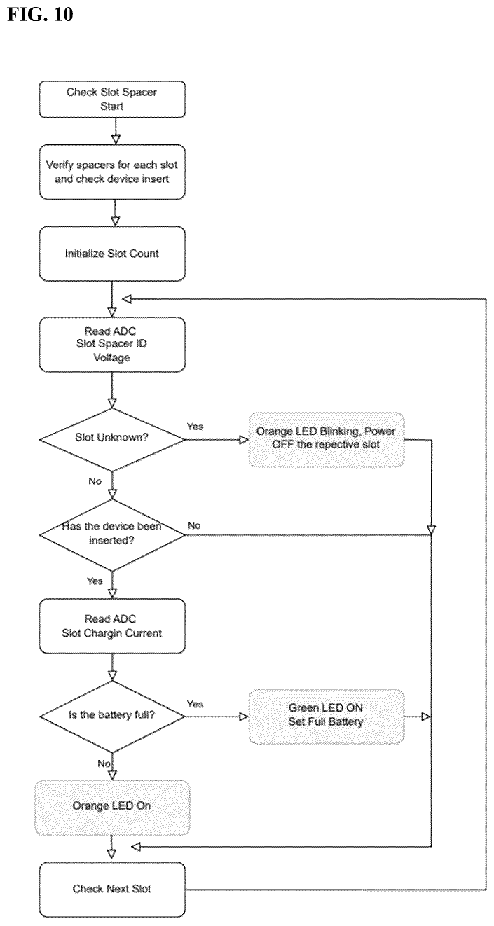

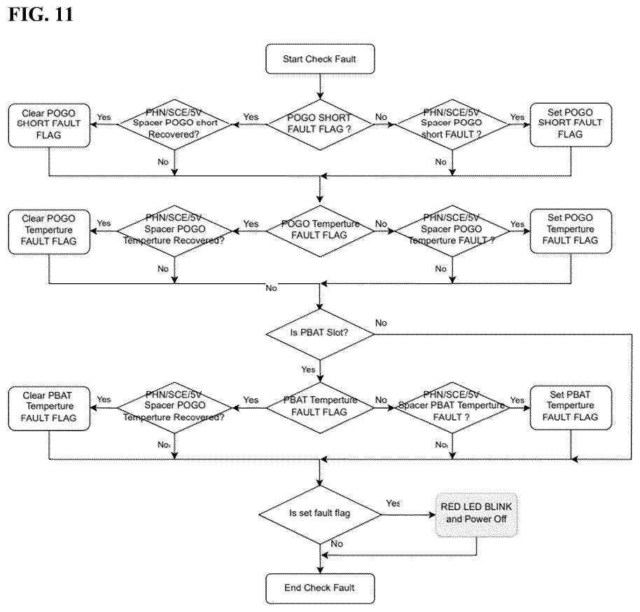

The present invention provides for a novel input power source detection within charger 400, which executed the steps outlined in FIG. 9 at Main Micro Controller Unit (MCU) 710, Power Control 720, and Power Delivery 730 levels. Other novel features provided within charger 400 include an inserted spacer detection process, the steps of which are outlined in FIG. 10. An additional point of novelty relates to a process for Device Fault Detection, which checks for temperature irregularities and the presence of faults, the steps of which are outlined in FIG. 11.

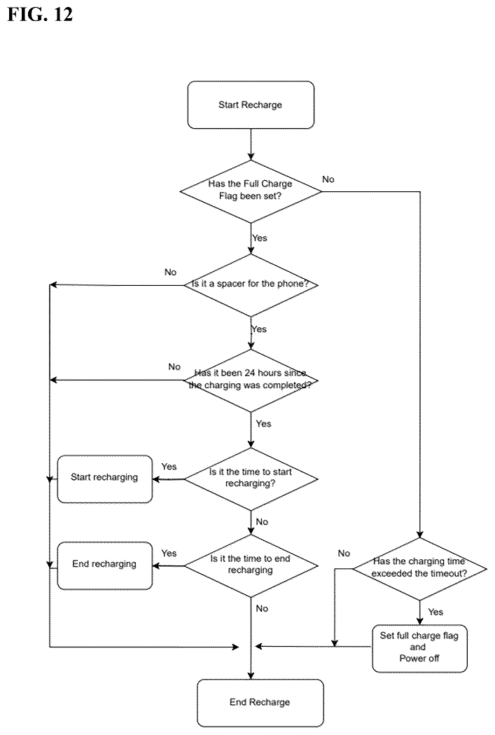

Charging a given battery of either the novel device, or any electronic device being charged therefrom constantly would shorten battery life cycle and could cause battery fire eventually. Therefore, it is desirable to stop charging battery once fully charged and recharge battery periodically to maintain battery charging level. As such, a novel battery recharging monitor is provided which can minimize power consumption, all while maximizing the battery life cycle. Provided within charging station 400 and/or spacer 130 is specialized circuitry that, in one illustrative embodiment, has microcode that executes steps in FIG. 12 that include monitoring the time since last charge, need for charge commencement and charge completion and means for setting flags based upon such determinations, as well as capacity to determine the device type (e.g., mobile phone, etc.).

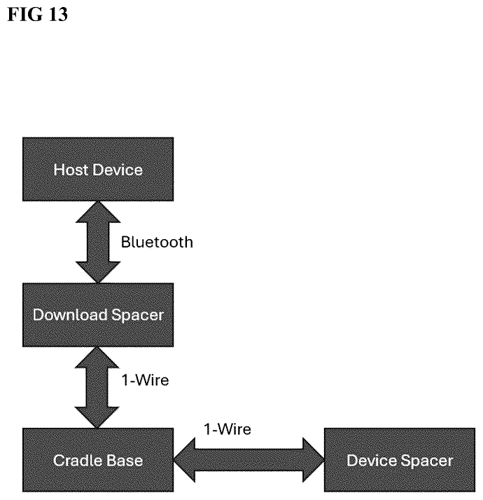

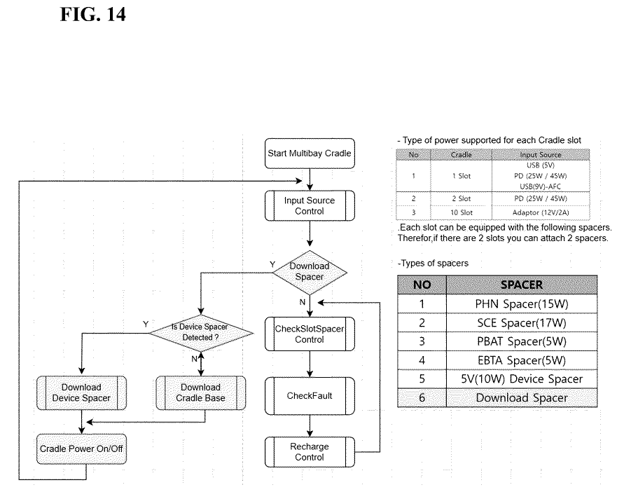

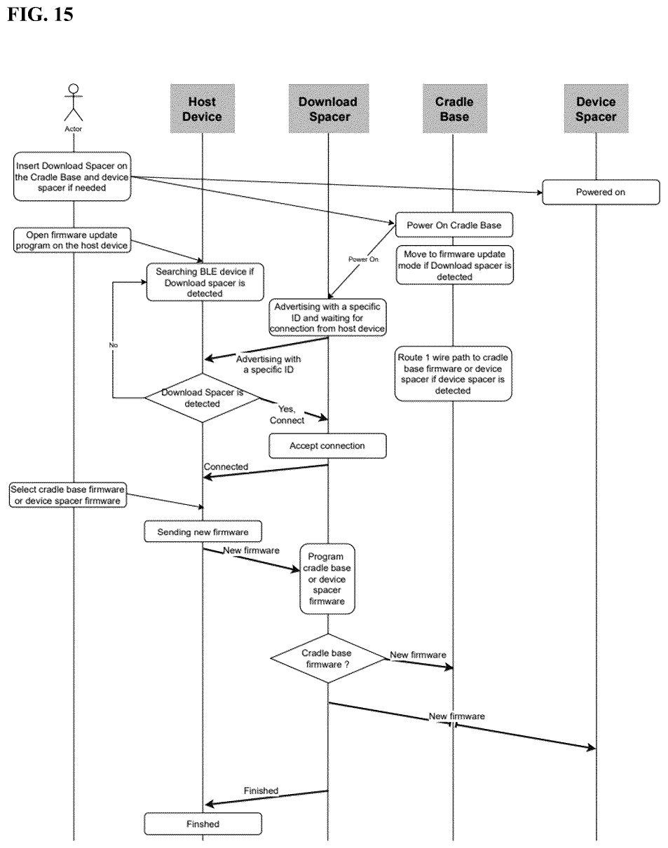

With ongoing reference to FIGS. 13-15, in an alternative embodiment, a Unified Program and Debug Interface (UDPI) type connection with a 1-Wire based module, essentially a wired half-duplex serial bus that typically provides low-speed (16.3 kbit/s) data communication and supply voltage over a single conductor. This connection may be employed as a download path for firmware updates that the spacer and/or the base may need for any given type of smart device that needs to be recharged. FIG. 13 therefore depicts an illustrative block diagram of the invention, in one embodiment entailing a 1-wire instantiation, of the physical and data connections between the host, spacer, and cradle. FIG. 14 depicts an illustrative flow diagram of the intelligent logic inventive charger implementing an innovative firmware update function, while FIG. 15 depicts an illustrative flow diagram of the intelligent logic inventive charger implementing, in further detail, an innovative firmware update function and the process flows between the relevant hardware portions involved in the overall charging apparatus. Guided with the illustrative flow processes in the referenced figures herein, the respective hardware elements can then perform their respective functions. Specifically, a base or charging station 400 is supplied with innovative micro-coded specialized logic circuitry that implenents the referenced flow processes is responsible for determining the type of power supplied from the external power source via 720 and/or 730, as well as distinguishing whether spacer 130 is installed or not, and supplying the corresponding level of power. Regulators 740 may be employed for converting the received DC power into the required charging voltage and supplying it to spacer 130. A Spacer ID is assigned using a predefined pull-down resistor value and Main MCU 710 recognizes the spacer ID after converting the predefined pull-down resistor to digital value using Analog to Digital Conversion. Essentially, Main MCU 710 has a list or table generated which has a fixed digital value converted from a given predefined pull-down resistor. Each digital value matches with spacer ID's predefined pull-down resistor value. If the spacer ID is not recognized as corresponding to a supported device, this novel circuitry will not supply power to the spacer in order to protect the device and/or any attachments thereto. If the download spacer is recognized, the aforementioned circuitry switches the status pin to UPDI pin for 1-wire communication. Thereafter, charger 400 supplies the appropriate voltage (e.g., 5V, 9V, etc.) to spacer 130, depending on the type of spacer and the number of installations. As such, spacer 130 receives power from charger 400 and charges any installed devices and batteries, according to one illustrative scheme:

Illustrative power source to charger 400:

| No | Cradle | Input Source |
|---|---|---|
| 1 | 1 Slot | USB Port(5 V) |
| | | PD Charger(25 W/45 W) |
| | | Adaptive Fast Charger USB (9 V) |
| 2 | 2 Slot | PD(25 W/45 W) |
| 3 | 10 Slot | AC/DC Power Adaptor(12/10 A) |

### Illustrative Spacer 130 Type:

| No | Spacer |
|---|---|
| 1 | Phone Spacer(15 W) |
| 2 | Extended Battery Spacer(17 W), |
| | SmartSled Spacer(17 W) |
| 3 | Phone Battery Spacer(5 W) |
| 4 | External Battery(5 W) |
| 5 | Other Device Spacer(10 W) |

The components employed for this, such as the detect switch, charger IC, and microcontroller, are installed on each spacer 130 (and/or Download spacer) in one illustrative embodiment. Spacer 130 informs charger 400 of its status via the status pin, which includes a resistor with a predefined value that is installed and connected to charger 400 via the spacer ID pin so that the download spacer can update charger 400 or spacer 130 firmware via the UPDI pin. In one embodiment, a firmware updater exists in the Download spacer which gets firmware from a host device (mobile phone, PC, tablet, etc.) and sends it to base Main MCU 710 or other MCU (such as might also be provided on spacer 130 or the like) via 1-wire path, essentially enabling Main MCU 710 to routes and enable illustrative 1-wire communication between download spacer and base (or other spacer 130).

FIG. 13 depicts an illustrative block diagram of the invention, in one embodiment entailing a 1-wire instantiation, of the physical and data connections between the host, spacer, and cradle Mulitibay charging cradle base and device spacer firmware can be updated via Bluetooth and by using 1-wire protocol. To update a multi-bay Cradle Base and Spacer firmware, following equipment are required: a host device (not depicted), running a firmware update program, a connection to download to charging station 400 or spacer 130, using Bluetooth® or other protocol, the ability to select cradle base firmware or device spacer firmware, and means to send firmware data to charging station 400 or spacer 130. Alternatively, a download spacer (not depicted) may be a separate module which accomplishes the above, and communicates between a host device and charger 400 via Bluetooth® or other protocol, so as to receive firmware data from the host device, whereby it subsequently programs cradle base or device spacer firmware by sending data using the novel 1 wire protocol module, such that charger 400 can detects download spacer and change to firmware update mode via 1-wire signal module to cradle base and/or device spacer.

As further detailed in FIG. 15, the specialized circuitry referenced above may utilize the illustrative process flow in one embodiment: charging station 400 checks the presence of the “Download spacer” and establishes the communication path for the base and spacer firmware updates. The selection of the firmware for the update is decided by the user. Given this, the inventive system and method may include preparing a host device such as a computer, smartphone, or tablet, and installing a firmware update program on the host device. Download spacer (not depicted) differs from device spacer 130 by being designed specifically to receive firmware updates from the host device and apply the updates to the base (charger 400) and spacer 130. Once the inventive device (typically via charger 400) is powered on, it detects download spacer and device spacer 130, routes 1-wire path to cradle base if device spacer 130 is not detected, but if device spacer 130 is detected then it routes 1 wire path to device spacer and changes to firmware update mode. Device spacer 130 can utilize Bluetooth® Low Energy (BLE) or the like from the host device using its Bluetooth connection by searching a BLE device on the host device and finding a Download spacer and then connect. Upon connecting, it will open the applicable firmware update program on the host device, including selecting charger 400 firmware or device spacer firmware. The firmware update will start when the host device sends new firmware data to download spacer via Bluetooth® and the Download spacer subsequently determines if new firmware is for cradle base or device spacer by checking the header information of the new firmware. Thereafter, the Download spacer programs charger 400 firmware or device spacer 130 firmware by using the above-referenced 1-wire protocol. When provisioned as such, downloads can be started in the host device by a user employing a local device that can connect via Bluetooth® or other protocol, whereby a host device program sends firmware data to the Download spacer. The Download spacer programs new firmware in the base (charger 400) Main MCU 710 or other spacer MCU using 1-wire communication.

Although there have been described particular embodiments of the present invention of a new and useful Universal Charging/Docking Station and Cradle with Intelligent Power Configuration and Modular Physical Structure, it is not intended that such references be construed as limitations upon the scope of this invention except as set forth in the following claims.

1. A charging dock for charging various portable electronic devices, said charging dock comprising:
at least one charging station having at least one docking cavity that is adapted to mount and hold a portable electronic device in a secure position while the charging station is charging a power supply of the device;
at least one spacer dimensioned to be positioned substantially inside said at least one docking cavity, thereby defining an interior dimension of the docking cavity for receiving a given portable electronic device having a given shape and size, when inserted therein; and
an intelligent charging module connected to said charging station, wherein said intelligent charging module has specialized circuitry that detects correct voltage levels and adjusts a resulting voltage level when charging a given said portable electronic device.

2. The device of claim 1, wherein said charging station further includes firmware update circuitry for firmware updating said charging station and said spacer.

3. The device of claim 2, wherein said at least one charging station includes a plurality of charging pins.

4. The device of claim 3, wherein said plurality of charging pins comprises 4 charging pins.

5. The device of claim 4, further including a Unified Program and Debug Interface type connection with a 1-Wire.

6. The device of claim 5, wherein said spacer further includes firmware update circuitry for updating cradle and spacer firmware.

7. The device of claim 6, further including a cradle for securing said electronic device when affixed to a mobile vehicle.

8. The device of claim 7, further including a cradle for securing said electronic device when affixed to a mobile vehicle.

9. The device of claim 6, further including a Download spacer in communication with said charging station.
